(19) United States
(12) Patent Application Publication
(10) Pub. No.: US 2013/0339482 A1
(43) Pub. Date: Dec. 19, 2013

(54) DATA TRANSMITTING SYSTEM, AND TRANSMITTING APPARATUS AND RECEIVING APPARATUS AND PROGRAM IN DATA TRANSMITTING SYSTEM

(71) Applicant: SAMSUNG ELECTRONICS CO., LTD, Suwon-si (KR)

(72) Inventor: Morio YOSHIMOTO, Yokohama-si (JP)

(21) Appl. No.: 13/918,351

(22) Filed: Jun. 14, 2013

(30) Foreign Application Priority Data
Jun. 15, 2012 (JP) 2012-135674
Mar. 28, 2013 (KR) 10-2013-0033664

(51) Int. Cl. H04L 1/00

(52) U.S. Cl. CPC H04L 1/004
USPC 709/217

(57) ABSTRACT

A data transmitting apparatus is provided. The data transmitting apparatus includes an image feature setting unit which is configured to set an image genre of coded image data; a first-priority extended layer setting which is configured to set a first-priority extended layer to be retransmitted according to a genre of an image set by the image feature setting unit; and a transmission processor which is configured to retransmit a transmitted image packet of the first-priority extended layer set by the first-priority extended layer setting unit, from among transmitted image packets for which a reception completion packet was not received from a receiving apparatus.

### CROSS-REFERENCE TO RELATED PATENT APPLICATIONS

This application claims priority from Japanese Patent Application No. 2012-135674, filed on Jun. 15, 2012, in the Japanese Intellectual Property Office, and Korean Patent Application No. 10-2013-0033664, filed on Mar. 28, 2013, in the Korean Intellectual Property Office, the disclosures of which are incorporated herein in their entirety by reference.

### BACKGROUND

1. Field

Systems and apparatuses consistent with exemplary embodiments relate to a data transmitting system that is used to transmit image data in a stream of data, and a transmitting apparatus, a receiving apparatus, and a computer readable medium comprising computer executable instructions for use in the data transmitting system.

2. Description of the Related Art

When image data is transmitted via the internet, a streaming method may be is used. The streaming method is a method in which data is transmitted from a transmitting apparatus to a receiving apparatus and simultaneously reproduced.

A scalable video coding (SVC) method of coding image data is used when transmitting image data according to circuit status or ability of a receiving end.

An example of an SVC method is an extension of the H.264 video coding standards. As in FIG. 4, the data structure in the coding may be divided into a base layer, which is formed with minimum necessary moving image elements, and an extended layer which is combined with the base layer to thereby increase image quality.

The base layer is a highly-reliable channel. Since the base layer is an essential data stream to reproduce image in the receiving end, the base layer is transmitted and received with high reliability using redundant checks such as forward error correction (FEC).

On the other hand, the extended layer is a less-reliable channel. The extended layer is divided into a space layer for increasing the accuracy of an image, a time layer for increasing a frame rate of a moving image, and a signal to noise (S/N) ratio layer for increasing an S/N ratio of an image.

Processes such as the FEC may not be applied to the extended layer. Thus, when the circuit status is not desirable, the extended layer may not be transmitted to the receiving apparatus. Since the essential base layer is always transmitted to the receiving apparatus, the extended layer that is transmitted from the transmitting apparatus without errors and the base layer are combined and decoded to obtain a transmitted image result that is appropriate for the status of the circuit.

However, according to Japanese Patent No. 3757857, when image data coded using an SVC method (hereinafter, “SVC image data”) is transmitted, a real time protocol (RTP), in which data is not retransmitted, is used as a transfer protocol, thus giving real-time data transmission priority over the reliability of data transmission.

Also, a data transmission system according to Japanese Patent No. 3757857 uses the RTP in which data is not retransmitted in principle, as a transfer protocol, but retransmits a portion of layers.

However, when streaming moving images and the like, a transmission control protocol (TCP), which provides reliable transmission by retransmitting data may be used as a transfer protocol. When transmitting SVC image data through TCP, if a transmitted image packet that failed to be transmitted to the receiving apparatus exists, all of the non-transmitted image packets are retransmitted. Thus, when transmitting SVC image data through TCP, at worst, even if the purpose of data transmission is only to reproduce moving images, transmitted image packets of even the extended layers that do not necessarily have to be transmitted to the receiving apparatus are completely retransmitted. Therefore, even though picture quality of moving images may be fixed to the best quality, the real-time performance is lost because of the delay until every transmitted image packets are received.

By combining the TCP and SVC method, variable picture quality according to the circuit status may not be automatically obtained, and the same best-effort image result as that of a combination of RTP and SVC method may not be obtained. Therefore, since an SVC method may not be embodied, data should be coded in a bit rate according to the circuit status, or a plurality of pieces of moving image data already coded should be provided.

Also, in the data transmission system according to Japanese Patent No. 3757857, the circuit status is monitored and thus, extended data, retransmitted according to the circuit status, is dynamically changed.

However, when extended data to be retransmitted according to the circuit status is set, depending on the image of the content recorded in the image data, extended layers that cannot contribute in increasing picture quality may be prioritized. Thus, the moving image may not be reproduced having a desired quality.

### SUMMARY

Exemplary embodiments provide a data transmitting system that uses a scalable video coding (SVC) method to enable best-effort image data delivery even when streaming data is transmitted through a transmission control protocol (TCP), and to simultaneously enable transmission of data in real-time and reproduction of high-quality moving images according to features of the content images in which the moving image data has been recorded.

A data transmitting system according to an exemplary embodiment includes a transmitting apparatus and a receiving apparatus, in which the image data is transmitted in stream-type data. The transmitting apparatus includes an image data memory unit storing coded image data which includes a base layer and an extended layer, and layer data which represents layers of the coded image data, as a pair, wherein the image data is coded using a scalable video coding (SVC) method; a transmitting unit generating the transmitted image packet which stores the coded image data together with layer data that corresponds to the coded image data, and transmitting the generated transmitted image packet to the receiving apparatus; and a retransmitting unit receiving the reception completion packet from the receiving apparatus, wherein the reception completion packet represents the transmitted image packet received from the receiving apparatus, and retransmitting the transmitted image packet of the first-priority extended layer set in the first-priority extended layer setting unit to the transmitting unit, among the transmitted image packets in which the reception completion packet is not received from the receiving apparatus within a predetermined time after the transmitting unit transmits the transmitted image packet The receiving apparatus includes a receiving unit receiving a transmitted image packet from a transmitting apparatus; and a reception completion processing unit transmitting a reception completion packet to the transmitting apparatus, wherein the reception completion packet represents the transmitted image packet received at least in the receiving unit. The transmitting or receiving apparatus further includes a an image feature setting unit setting an image feature of the image data; and a first-priority extended layer setting unit setting a first-priority extended layer that is an extended layer to be retransmitted according to the image feature set by the image feature setting unit.

The retransmitting unit retransmits the transmitted image packet of the first-priority extended layer set in the first-priority extended layer setting unit to the transmitting unit, among the transmitted image packets in which the reception completion packet is not received from the receiving completion processing unit. Therefore, even when using a transfer protocol such as TCP, which provides reliable transmission by retransmitting data, if circuit status is not desirable, extended layers other than the first-priority extended layer is not retransmitted, and thus at least a base layer and an extended layer set as the first-priority extended layer may be combined and decoded to reproduce a moving image. However, if circuit status is desirable, all extended layers are transmitted to the data receiving apparatus, and thus a moving image may be reproduced with the highest quality. That is, according to the data transmitting system of an exemplary embodiment, even when using a transfer protocol such as TCP, which provides reliable transmission by retransmitting data, a moving image having various resolutions according to the circuit status may be reproduced, and thus, best-effort image data delivery may be provided.

Also, the transmitting or receiving apparatuses may include the image feature setting unit setting an image feature of image data; and the first-priority extended layer setting unit setting a first-priority extended layer that is an extended layer to be retransmitted according to the image feature set by the image feature setting unit. Therefore, the retransmitting unit may retransmit an extended layer according to the image feature of image data. Also, image data may always be decoded according to a combination of the extended layer and base layer, which is fit for content images. Thus, a moving image may be reproduced in desirable quality.

Therefore, according to an exemplary embodiment, TCP may be used while features of SVC method are exhibited. Also, image data may be decoded and a moving image may be reproduced depending on extended layers of content images recorded in the image data.

To identify the feature of the image data using a simple structure, and set a first-priority extended layer without overloading calculation, the image feature setting unit sets a genre of recorded content images based on metadata of the image data; and the first-priority extended layer setting unit sets the first-priority extended layer depending on the genre of content images set by the image feature setting unit.

In a case where frame rates for smooth playback of a moving image are considered to be important, to increase quality of a moving image when streaming data, the extended layer of coded image data includes a space layer, a time layer, and a signal to noise (S/N) ratio layer; the image feature setting unit sets intensity of motions in content images recorded in the image data; and the first-priority extended layer setting unit sets the time layer as the first-priority extended layer when the intensity of motion of content images, which is set by the image feature setting unit, is a predetermined value or above.

To reproduce a moving image according to a resolution of the content images recorded in the image data, the image feature setting unit sets a resolution based on the amount of high-frequency components when the image data is coded using SVC method; and the first-priority extended layer setting unit sets the space layer as the first-priority extended layer when the resolution is a predetermined level or above.

Even if a special unit is not provided in the data receiving apparatus, for the retransmitting unit to be able to only retransmit the transmitted image packet of the first-priority extended layer which is transmitted from the transmitting unit, the data transmitting apparatus further includes a layer identifying unit identifying a layer of coded image data, which is stored in the transmitted image packet from the transmitting unit, based on layer data. The transmitted image packet is not retransmitted, if the layer identifying unit determines that the identified layer of coded image data is an extended layer the first-priority extended layer.

On the other hand, even if a special unit is not provided in the data transmitting apparatus, for the data retransmitting unit to be able to only retransmit the transmitted image packet of the first-priority extended layer which is transmitted from the transmitting unit, the reception completion processing unit transmits the reception completion packet to the transmitting apparatus if the transmitted image packet that is not received in the receiving unit, is an extended layer other than the first-priority extended layer, among the transmitted image packets that is not received in the receiving unit.

For the data receiving apparatus to recover a transmitted image packet that is not received in the data receiving apparatus, and for an extended layer other than the first-priority extended layer, even if not error-corrected, to not be transmitted and thus provide the best-effort image data delivery, the data receiving apparatus further includes a forward error correction (FEC) unit executing a FEC process based on the transmitted image packet received in the receiving unit. The reception completion processing unit transmits the reception completion packet to the transmitting apparatus, in the case that the transmitted image packet that may not be error-corrected in the FEC unit is a transmitted image packet that is an extended layer other than a first-priority extended layer.

To provide best-effort moving image playback even if using a combination of a transfer protocol such as TCP, which provides reliable transmission by retransmitting data, and SVC method, provided is a transmitting apparatus for use in a data transmitting system that transmits stream-type image data in which the data transmitting system includes a transmitting apparatus including an image data memory unit storing coded image data which includes a base layer and an extended layer, and layer data which represents layers of the coded image data, as a pair, wherein the image data is coded using SVC method; a transmitting unit generating a transmitted image packet which stores the coded image data together with the layer data that corresponds to the coded image data, and transmitting the generated transmitted image packet to a receiving apparatus; and a retransmitting unit receiving a reception completion packet from the receiving apparatus, wherein the reception completion packet represents the transmitted image packet received from the receiving apparatus, and retransmitting the transmitted image packet of the first-priority extended layer set in the first-priority extended layer setting unit to the transmitting unit, among the transmitted image packets in which the reception completion packet is not received from the receiving apparatus within a predetermined time after the transmitting unit transmits the transmitted image packet. Also, the receiving apparatus comprising: a receiving unit receiving the transmitted image packet from the transmitting apparatus; and a reception completion processing unit transmitting the reception completion packet to the transmitting apparatus, wherein the reception completion packet represents the transmitted image packet received at least in the receiving unit. The transmitting apparatus further includes an image feature setting unit setting an image feature of the image data; and a first-priority extended layer setting unit setting a first-priority extended layer that is an extended layer to be retransmitted according to the image feature set by the image feature setting unit. The retransmitting apparatus retransmits the transmitted image packet of the first-priority extended layer set in the first-priority extended layer setting unit to the transmitting unit, among the transmitted image packets in which the reception completion packet is not received from the receiving completion processing unit.

Also, to provide the same best-effort moving image playback as described above, provided is a receiving apparatus for use in a data transmitting system that transmits stream-type image data in which the data transmitting system includes a transmitting apparatus includes an image data memory unit storing the coded image data which includes a base layer and an extended layer, and layer data which represents layers of the coded image data, as a pair, wherein the image data is coded using SVC method; a transmitting unit generating a transmitted image packet which stores the coded image data together with the layer data that corresponds to the coded image data, and transmitting the generated transmitted image packet to the receiving apparatus; a retransmitting unit receiving the reception completion packet from the receiving apparatus, wherein the reception completion packet represents the transmitted image packet received from the receiving apparatus, and retransmitting the transmitted image packet of the first-priority extended layer set in the first-priority extended layer setting unit to the transmitting unit, among the transmitted image packets in which the reception completion packet is not received from the receiving apparatus within a predetermined time after the transmitting unit transmits the transmitted image packet. Also, the receiving apparatus comprising: a receiving unit receiving the transmitted image packet from the transmitting apparatus; and a reception completion processing unit transmitting a reception completion packet to the transmitting apparatus, wherein the reception completion packet represents the transmitted image packet received at least in the receiving unit. The receiving apparatus further includes an image feature setting unit setting an image feature of the image data; and a first-priority extended layer setting unit setting a first-priority extended layer that is an extended layer to be retransmitted according to the image feature set by the image feature setting unit.

To use a recording medium to newly install a program in the conventional transmitting and receiving apparatuses, and thus transmit SVC image data depending on the circuit status even if using TCP which provides reliable transmission by retransmitting data, provided is a non-transitory computer readable medium comprising computer executable instructions to be executed in a data transmitting system, the instructions configured to execute the operations of: storing coded image data which includes a base layer and an extended layer, and layer data which represents layers of the coded image data, wherein the image data is coded using a scalable video coding (SVC) method; setting an image feature of the coded image data; setting a first-priority extended layer that is an extended layer to be retransmitted according to the image feature; generating a transmitted image packet which stores the coded image data together with the layer data that corresponds to the coded image data, and transmitting the generated transmitted image packet to a receiving apparatus; receiving the transmitted image packet from the transmitting apparatus; transmitting a reception completion packet to the transmitting apparatus, wherein the reception completion packet indicates that the transmitted image packet has been received by a receiving apparatus; receiving a reception completion packet from the receiving apparatus, and retransmitting the transmitted image packet, from among transmitted image packets in which the reception completion packet is not received from the receiving apparatus within a predetermined time after transmitting the transmitted image packet . The retransmitting comprises retransmitting the transmitted only an image packet of the first-priority extended layer from among the transmitted image packets in which the reception completion packet is not received from the receiving apparatus.

According to an aspect of an exemplary embodiment, a data transmitting method is provided. The method includes: setting an image feature of coded image data, setting a first-priority extended layer that is an extended layer to be retransmitted according to the image feature, and retransmitting only an image packet comprising the first-priority extended layer from among transmitted image packets for which a reception completion packet was not received.

According to another aspect of an exemplary embodiment, a data receiving method is provided. The method includes: receiving a transmitted image packet, executing a forward error correction process based on the received transmitted image packet, and transmitting a reception completion packet indicating that the transmitted image packet has been received in the case that the transmitted image packet may not be error-corrected according to the forward error correction process and is an extended layer other than a first-priority extended layer.

### BRIEF DESCRIPTION OF THE DRAWINGS

The above and other features and advantages will become more apparent by describing in detail exemplary embodiments thereof with reference to the attached drawings in which:

FIG. 1 is a schematic diagram of a data transmitting system according to an exemplary embodiment;

FIG. 2 is a block diagram of a data transmitting system according to an exemplary embodiment;

FIG. 3 is a block diagram of a transmission processing unit and a receiving processing unit according to an exemplary embodiment; and

FIG. 4 is a schematic diagram of a structure of image data coded using scalable video coding (SVC) method.

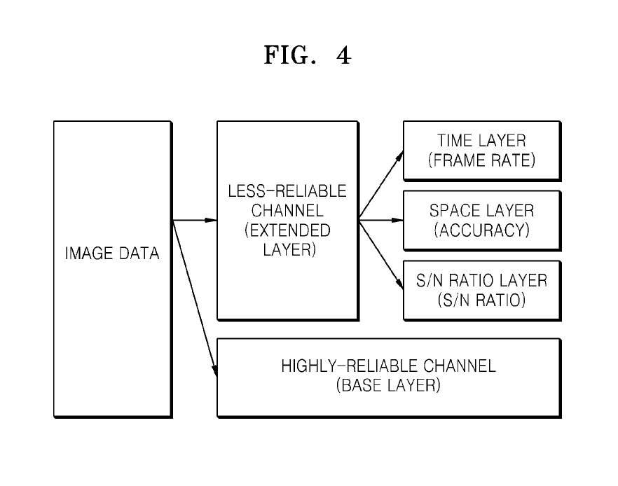

### DETAILED DESCRIPTION OF THE EXEMPLARY EMBODIMENTS

Exemplary embodiments will be described with reference to the attached drawings.

A data transmitting system 200 streams image data from a transmitting apparatus 101 to a receiving apparatus 100.

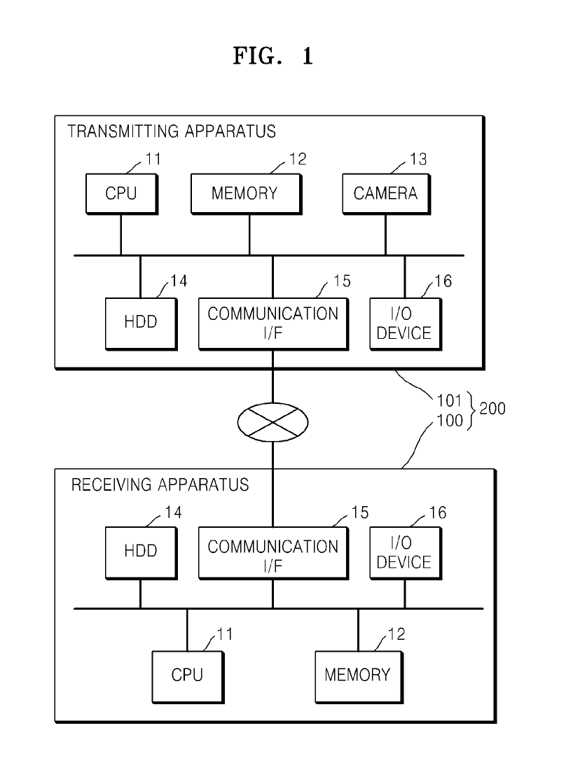

As in FIG. 1, the transmitting and receiving apparatuses 101 and 100 may be a computer including a CPU 11, a memory 12, a HDD 14 or a flash memory (not shown), a communication interface (I/F) 15, and an input-output (I/O) device 16. The CPU 11 executes a program stored in the memory 12, thereby providing various functions of the computer. Also, the transmitting and receiving apparatuses 101 and 100 transfer information using networks such as internet, and use transmission control protocol (TCP) as a transfer protocol instead of real time protocol (RTP).

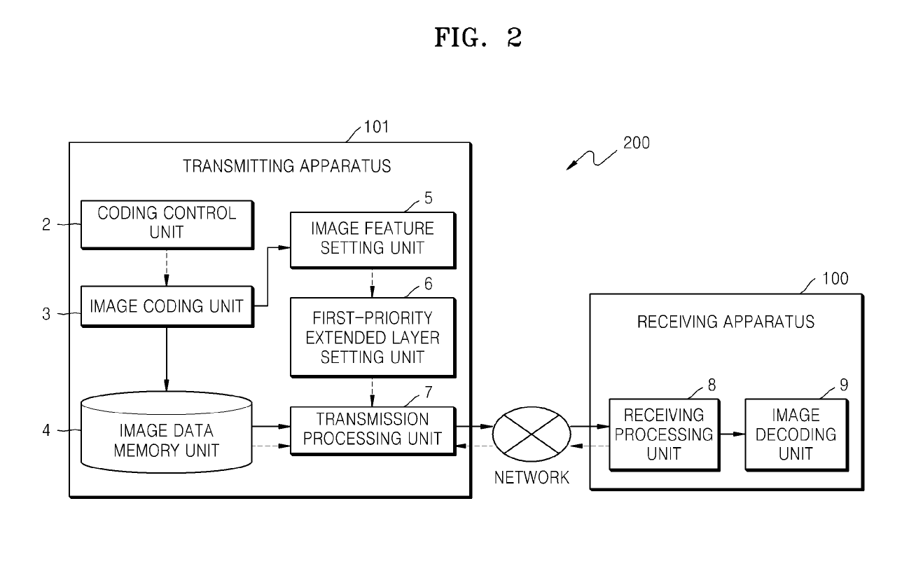

The transmitting apparatus 101 may further include a camera 13 for photographing. The transmitting apparatus 101 codes a photographed image data using a scalable video coding (SVC) method, and transfers the image data coded using SVC method (hereinafter, “SVC image data”) to the receiving apparatus 100. Also, as in FIG. 2, the transmitting apparatus 101 may include a coding control unit 2 (e.g., a coding controller), an image coding unit 3 (e.g., an image coder), an image data memory unit 4 (e.g., image data memory), an image feature setting unit 5, an first-priority extended layer setting unit 6, and a transmission processing unit 7 (e.g., a transmission processor).

The receiving apparatus 100 determines whether or not to a transmitted image packet that is not normally received or has errors needs to be retransmitted from the transmitting apparatus 101. Then, if the transmitted image packet needs to be retransmitted, the receiving apparatus 100 receives the retransmitted image packet, decodes SVC image data, and reproduces a moving image. That is, as in FIG. 2, the receiving apparatus 100 may include a receiving processing unit 8 (e.g., a receiving processor), and an image decoding unit 9 (e.g., an image decoder).

Hereinafter, the units of the transmitting and receiving apparatuses 101 and 100, a process of coding an image data using SVC method, and operation of a packet in a transceiving process will be described in detail.

The image coding unit 3 codes an image data photographed using the camera 13, using coding such as SVC which is an extension of the H.264 video coding standards. In detail, the image coding unit 3 codes an image data into SVC image data that is formed of a base layer which includes minimum necessary moving image elements, and an extended layer which is combined with the base layer to thereby increase image quality.

The coding control unit 2 controls a process of choosing a layer, determining how many types of layers to divide thereinto so that the image coding unit 3 may code the image data using SVC method. The coding control unit 2 divides the extended layer into three types of layers, that is, a space layer for increasing accuracy of an image, a time layer for increasing frame rate of a moving image, and an S/N ratio layer for increasing a signal to noise (S/N) ratio of an image. The coding control unit 2 combines the base layer and the divided extended layers and decodes the combined layers, and thus, moving image of a desirable picture quality may be embodied.

The image data memory unit 4 stores coded image data which includes a base layer and an extended layer, and layer data which represents layers of the coded image data, as a pair, in which the image data is coded in the image coding unit 3.

The transmission processing unit 7 transmits coded image data packet to the receiving apparatus 100, and simultaneously, retransmits all transmitted image packets that did not receive the reception completion packet from the receiving apparatus 100.

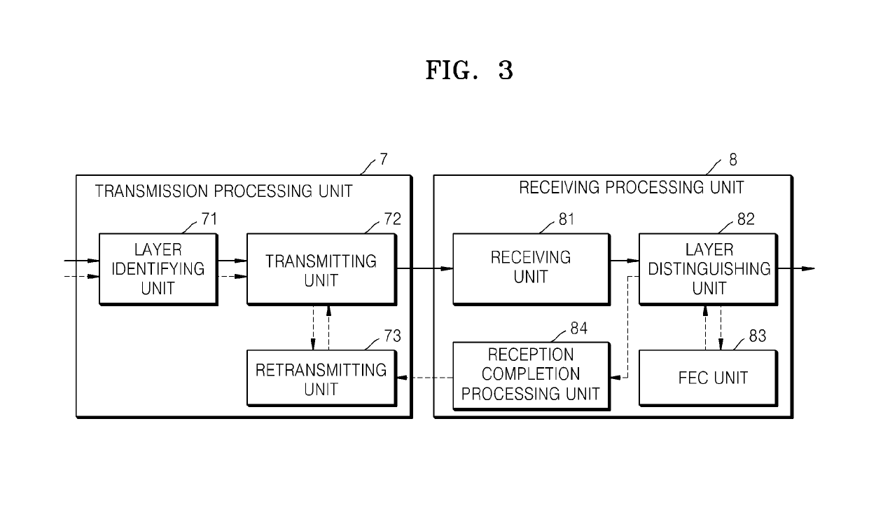

Furthermore, as illustrated in FIG. 3, the transmission processing unit 7 includes a layer identifying unit 71, a transmitting unit 72 (e.g., a transmitter), and a retransmitting unit 73 (e.g., a re-transmitter).

The layer identifying unit 71 receives the coded image data and layer data that correspond to the layers of coded image data from the image data memory unit 4. Then, the layer identifying unit 71 identifies the layer of the received coded image data based on the received layer data.

The transmitting unit 72 generates a transmitted image packet which stores all the layer data corresponding to SVC image data identified in the layer identifying unit 71, and then, transmits the generated image packet to the receiving apparatus 100. Also, the transmitting unit 72 stores sequence information in the retransmitting unit 73 based on the layer identification by the layer identifying unit 71, in which the sequence information includes information regarding which portion of the packet transmission sequence is the transmitted image packet including the base layer, the time layer, the space layer, or the S/N ratio layer.

The retransmitting unit 73 receives a reception completion packet from the receiving apparatus 100, in which the reception completion packet is a transmitted image packet received in the receiving apparatus 100. If the transmission unit transmits an image packet to the receiving apparatus 100, but the transmitted image packet does not receive a reception completion packet from the receiving apparatus 100 within a predetermined time, then, the retransmitting unit 73 retransmits a transmitted image packet to the transmitting unit 72.

In detail, based on the sequence information of the transmitted image packets that did not receive a reception completion packet from a reception completion packet processing unit 84, the retransmitting unit 73 retransmits a transmitted image packet of a first-priority extended layer to the transmitting unit 72, and simultaneously, ends retransmission if a transmitted image packet that did not receive a reception completion packet that is of an extended layer other than the first-priority extended layer.

The image feature setting unit 5 identifies motion intensity of content images recorded in the image data, based on motion vector information when an image data is SVC coded using the image coding unit 3, and then, sets image data features. Also, the image feature setting unit 5 sets an image feature based on the genre of the content images stored in metadata of the image data. For example, if the genre of the content images is sports, the image feature setting unit 5 identifies the motion of the content images as having intense motion. Also, if the amount of high-frequency units is above a predetermined level when coding an image data using SVC, the image feature setting unit 5 identifies the content images as detailed content images.

Based on the motion intensity, amount of noise, and resolution of content images identified in the image feature setting unit 5, the first-priority extended layer setting unit 6 determines whether the time layer, the space layer, or the S/N ratio layer is the first-priority extended layer, or, how to retransmit each extended layer or execute forward error correction (FEC) to each extended layer. For example, as described above, if the genre of content images is identified as having intense motion, the first-priority extended layer setting unit 6 sets the time layer as the first-priority extended layer to maintain a frame rate above a predetermined level when reproducing a moving image. Also, for a moving image of another genre such as high-resolution content images in which the motion thereof is not as intense as that of the content images described above and includes much detail, the first-priority extended layer setting unit 6 sets the space layer as the first-priority extended layer. Also, if content images include noise that is greater than a predetermined amount of noise, the S/N ratio layer is set as the first-priority extended layer.

Hereinafter, the receiving apparatus 100 is described in detail.

As illustrated in FIG. 2, the receiving apparatus 100 includes a receiving processing unit 8 and an image decoding unit 9.

As illustrated in FIG. 3, the receiving processing unit 8 includes a receiving unit 81 (e.g., a receiver), a layer distinguishing unit 82 (e.g., a layer distinguisher), a forward error correction (FEC) unit 83 (e.g., a forward error corrector), and the reception completion packet processing unit 84 (e.g., a reception completion processor). The receiving processing unit 8 receives an image packet transmitted from the transmitting apparatus 101. Among the transmitted image packets in which a portion thereof may be not transmitted due to circuit status, or damage and are thus unrecoverable, the receiving processing unit 8 retransmits the transmitted image packets of a base layer and transmitted image packets of an extended layer set as a first-priority extended layer.

The receiving unit 81 receives sequence information, which is information regarding a sequence number of the transmitted image packet of a layer, from the transmitting unit 72. At the same time, the receiving unit 81 receives image packets transmitted from the transmitting unit 72.

Based on layer data, the layer distinguishing unit 82 distinguishes a layer of coded image data stored in the transmitted image packet received in the receiving unit 81 based on the layer data. If the transmitted image packet received in the layer distinguishing unit 82 has errors or omissions, the FEC unit 83 may execute FEC on the packet received in the layer distinguishing unit. The layer distinguishing unit 82 sends the recovered coded image data to the image decoding unit 9 to reproduce a moving image.

The reception completion packet processing unit 84 transmits a reception completion packet, which is a transmitted image packet received in the receiving unit 81, to the transmitting apparatus 101 for the retransmitting unit 83 to not start retransmission. Also, if a transmitted image packet having errors that are not corrected using the FEC unit 83, the reception completion packet processing unit 84 does not transmit a reception completion packet for the transmitted image packet to the transmitting apparatus 101, thereby causing the retransmission of the transmitted image packet.

Based on a transmitted image packet received in the receiving unit 81 and a transmitted image packet recovered in the FEC unit 83, the image decoding unit 9 decodes all the usable layers. Data received in the receiving unit 81 includes a base layer and a first-priority extended layer, and the two layers are combined and thus decoded. For example, when circuit status is desirable, the image decoding unit 9 combines extended layers other than the first-priority extended layer, and decodes the combined layers, to thus reproduce a moving image of a higher resolution.

According to the data transmitting system 200, even when using transfer protocols such as TCP, which provides reliable transmission by retransmitting data, if the retransmitting unit 73 did not receive the reception completion packet within a predetermined time after the transmitted image packet is transmitted, the retransmitting unit 73 orders the transmitting unit 72 to only retransmit the transmitted image packet of the first-priority extended layer, and to not retransmit the transmitted image packet other than the transmitted image packet of the first-priority layer. Therefore, when circuit status is desirable, a high-resolution moving image which includes all extended layers may be reproduced. However, when circuit status is not desirable, a portion of extended layers is omitted from the extended layers, and thus real-time playback of a moving image may be executed. That is, even when using a combination of a transfer protocol such as TCP, which provides reliable transmission by retransmitting data, and the SVC method, a moving image may be reproduced having various resolutions according to the circuit status, and thus, best-effort delivery may be provided.

In addition, the transmitting and receiving apparatuses 101 and 100 include the image feature setting unit 5 which sets features of image data, and the first-priority extended layer setting unit 6 which sets a first-priority extended layer which is an extended layer to be retransmitted, based on the image feature identified in the image feature setting unit 5. Therefore, an extended layer may be retransmitted according to the features of image data, and a moving image which combines extended layers and a base layer included in content images may always be reproduced, regardless of the circuit status.

In other words, since a first-priority extended layer is set according to the features of content images and not regarding the circuit status, an appropriate extended layer may be always transmitted to each image data, and the playback quality of a moving image may be increased.

According an exemplary embodiment, the retransmitting unit 73 of the transmitting apparatus 101 only retransmits transmitted image data of a first-priority extended layer. However, using the reception completion packet processing unit 84 of the receiving apparatus 100, only the first-priority extended layer that is not received in the receiving apparatus 100 may be retransmitted.

In the transmitting apparatus 101 according to another exemplary embodiment, the structures of the transmitting unit 72 and the retransmitting unit 73 are different than those described above.

In detail, based on layer identification from a layer identifying unit 71, the transmitting unit 72 transmits sequence information to the receiving apparatus 100 in advance. The sequence information is information regarding which portion of the sequence is a transmitted image packet including a base layer, a time layer, a space layer, or an S/N ratio layer.

Also, the retransmitting unit 73 according to another exemplary may not distinguish any transmitted image packets, and retransmit all transmitted image packets that did not receive a reception completion packet.

The reception completion packet processing unit 84 of the receiving apparatus 100 according to another exemplary embodiment is different from the reception completion packet processing unit 84 described above.

Based on the relationship between a sequence number and layer of a transmitted image packet received in the receiving unit 81, the reception completion packet processing unit 84 estimates data of a layer of the transmitted image packet, which has not been received yet, and stores the estimated data therein. If the received transmitted image packet that is not transmitted includes a base layer which is necessary for reproducing a moving image, the reception completion packet processing unit 84 does not transmit the reception completion packet until the transmitted image packet is received. Also, the reception completion packet processing unit 84 does not transmit the reception completion packet until actually receiving a transmitted image packet of an extended layer, in which the extended layer is a first-priority extended layer set in a first-priority extended layer setting unit 6.

Also, according to the relationship between the sequence numbers and layers, if a transmitted image packet that is not received includes data of an extended layer that is other than a first-priority extended layer, even if a transmitted image packet is not received, the reception completion packet processing unit 84 transmits a reception completion packet to the retransmitting unit 73, forcing retransmission to stop. In addition, if a transmitted image packet, which is not recovered using the FEC unit 83, is a transmitted image packet of an extended layer other than a first-priority extended layer, then, the reception completion packet processing unit 84 transmits a reception completion packet to the receiving apparatus 101.

That is, the reception completion packet processing unit 84 does not retransmit a reception completion packet until actually receiving a base layer thereof, which is essential for reproducing moving image, and a portion of extended layers thereof, which are protected to maintain the resolution of image data to a certain level. However, if a transmitted image packet of an extended layer other than a first-priority extended layer is not received, the reception completion packet processing unit 84 transmits a dummy reception completion packet to the retransmitting unit 73 to stop retransmission of the transmitted image packet.

As described above, using the data transmitting system 200 according to the another exemplary embodiment, even if a transmitted image packet of an extended layer having lower priority, which does not have to be retransmitted, is not received, the reception completion packet processing unit 84 may transmit the dummy reception completion packet to the retransmitting unit 73 and force retransmission to stop. Thus, even if a unit retransmitting the transmitted image packet of the first-priority extended layer is not provided in the data transmitting apparatus 101, the reception completion packet processing unit 84 may only receive the first-priority extended layer.

Therefore, even when using both TCP and SVC, the data transmitting system 200 according to the first embodiment may be embodied by only using the units of the receiving apparatus 100.

Hereinafter, other exemplary embodiments will be described in detail.

According to the exemplary embodiments described above, the first-priority extended layer setting unit 6 sets only one extended layer as a first-priority extended layer. However, according to another exemplary embodiment, a plurality of extended layers may be set as first-priority layers. Also, the first-priority extended layer setting unit 6 may prioritize extended layers according to the identified moving image genre of each layer. In this case, for a transmitted image packet of a higher-priority extended layer, the reception completion packet processing unit set longer delay time to transmit a reception completion packet. Therefore, transmission may be controlled more in detail, and decoding quality may be controlled according to circuit status, thus providing best-effort control of decoding quality.

According to the exemplary embodiments described above, the image feature setting unit 5 and first-priority extended layer setting unit 6 are provided in the transmitting apparatus 101. However, the image feature setting unit 5 and first-priority extended layer setting unit 6 may be provided in the receiving unit 100. Also, the image feature setting unit 5 and first-priority extended layer setting unit 6 may be provided in both transmitting and receiving apparatuses 101 and 100.

According to the exemplary embodiments described above, image data photographed using the camera 13 is sequentially coded using SVC. However, the image decoding unit 3 may code image data using SVC in advance, store SVC image data in the image data memory unit 4, and transmit the stored SVC image data to the receiving apparatus 100.

Also, if an extended layer data having a resolution of 1920×1080 (full high resolution, hereinafter “FHD”) is transmitted, a receiving apparatus having a display of a resolution of 640×480 (VGA) provided thereon may not be able to support resolution thereof. In addition, although a decoding unit of the receiving apparatus may support up to a resolution of 1280×720 (720P), since the receiving apparatus may not be able to support the FHD extended layer data, the receiving apparatus and a transmitting apparatus negotiate in advance to exchange maximum resolution or bit rate that may be supported by the receiving apparatus, and thus the transmitting apparatus reduces the resolution or bit rate of the extended layer data to be less than the maximum resolution or bit rate that may be supported by the receiving apparatus. The method described above may be embodied even when the resolution or bit rate of the extended layer data is limited as described above.

Also, each unit described above may be installed as a new program in the conventional transmitting and receiving apparatuses. SVC of the image coding unit is not limited to exemplary embodiments described above. For example, layers of an extended layer may be divided into more than three classes.

Therefore, even when streaming over TCP to transmit image data, if circuit status is not desirable, only the desired extended layer is retransmitted to the receiving apparatus, and thus a moving image may be reproduced in a quality according to circuit status. Also, since the first-priority extended layer is set depending on the features of content images recorded in the image data, best-effort image data delivery and simultaneously, real-time and high-quality reproduction of moving images depending on the features of the content images in which the moving image data has been recorded may be enabled.

While exemplary embodiments have been particularly shown and described with reference to drawings, it will be understood by those of ordinary skill in the art that various changes in form and details may be made therein without departing from the spirit and scope of the inventive concept as defined by the following claims.

What is claimed is:

1. A data transmitting apparatus comprising:
an image feature setting unit which is configured to set an image feature of coded image data;
a first-priority extended layer setting unit which is configured to set a first-priority extended layer that is an extended layer to be retransmitted according to the image feature set by the image feature setting unit; and
a transmission processor which is configured to retransmit a transmitted image packet of the first-priority extended layer set by the first-priority extended layer setting unit, from among transmitted image packets for which a reception completion packet was not received from a receiving apparatus.

2. The data transmitting apparatus according to claim 1, further comprising an image data memory which is configured to store the coded image data which includes a base layer and an extended layer, and layer data which represents layers of the coded image data, wherein the image data is coded using a scalable video coding (SVC) method.

3. The data transmitting apparatus according to claim 1, wherein the transmission processor comprises:
a transmitter which is configured to generate the transmitted image packet which stores the coded image data together with layer data that corresponds to the coded image data, and transmit the generated transmitted image packet to the receiving apparatus; and
a re-transmitter which is configured to receive the reception completion packet from the receiving apparatus, and retransmit the transmitted image packet of the first-priority extended layer set in the first-priority extended layer setting unit to the transmitting unit, from among the transmitted image packets for which the reception completion packet is not received from the receiving apparatus within a predetermined time after the transmitter transmits the transmitted image packet,
wherein the reception completion packet comprises information indicating that the transmitted image packet was received by the receiving apparatus.

4. The data transmitting apparatus according to claim 1,
wherein the image feature setting unit is configured to set a genre of content images based on metadata of the coded image data; and
wherein the first-priority extended layer setting unit is configured to set the first-priority extended layer according to the genre of content images set by the image feature setting unit.

5. The data transmitting apparatus according to claim 1,
wherein the extended layer of the coded image data comprises a space layer, a time layer, and a signal to noise (S/N) ratio layer;
wherein the image feature setting unit is configured to set an intensity of motion in content images recorded in the coded image data; and
wherein the first-priority extended layer setting unit is configured to set the time layer as the first-priority extended layer when the intensity of motions of the content images is a predetermined value or above.

6. The data transmitting apparatus according to claim 1,
wherein the extended layer of the coded image data comprises a space layer, a time layer, and a signal to noise (S/N) ratio layer;
wherein the image feature setting unit is configured to set an intensity of motion of content images recorded in the coded image data based on motion vector information when the coded image data is coded using a scalable video coding (SVC) method, and;
wherein the first-priority extended layer setting unit is configured to set the space layer or the S/N ratio layer as the first-priority extended layer when the intensity of motion of the content images is a predetermined level or below.

7. The data transmitting apparatus according to claim 1 further comprising:
a layer identifying unit which is configured to identify a layer of the coded image data, which is stored in the transmitted image packet transmitted from the transmitting unit, based on layer data,
wherein the transmitted image packet is not retransmitted, even when the reception completion packet is not received, if the layer identifying unit determines that the identified layer of coded image data is an extended layer the first-priority extended layer.

8. The data transmitting apparatus according to claim 1,
wherein the extended layer of the coded image data includes a space layer, a time layer, and a signal to noise (S/N) ratio layer;
wherein the image feature setting unit is configured to set a resolution based on the amount of high-frequency components when the coded image data is coded using a scalable video coding (SVC) method; and
wherein the first-priority extended layer setting unit is configured to set the space layer as the first-priority extended layer when the resolution is a predetermined level or above.

9. A data receiving apparatus comprising:
a receiver which is configured to receive a transmitted image packet from a transmitting apparatus;
a reception completion processor which is configured to transmit a reception completion packet to the transmitting apparatus, wherein the reception completion packet indicates that the transmitted image packet has been received by the receiver; and
a forward error corrector (FEC) which is configured to execute a forward error correction process based on the transmitted image packet being received by the receiver,
wherein the reception completion processor is configured to transmit the reception completion packet to the transmitting apparatus, in the case that the transmitted image packet that may not be error-corrected in the FEC is a transmitted image packet that is an extended layer other than a first-priority extended layer.

10. The data receiving apparatus according to claim 9, wherein the reception completion processor is configured to transmit the reception completion packet to the transmitting apparatus if a transmitted image packet that is not received is of an extended layer other than the first-priority extended layer.

11. A data transmitting system comprising a transmitting apparatus and a receiving apparatus,
wherein the transmitting apparatus comprises:
an image data memory which is configured to store coded image data which includes a base layer and an extended layer, and layer data which represents layers of the coded image data, wherein the image data is coded using a scalable video coding (SVC) method;
a transmitter which is configured to generate a transmitted image packet which stores the coded image data together with layer data that corresponds to the coded image data, and transmit the generated transmitted image packet to the receiving apparatus; and
a re-transmitter which is configured to receive a reception completion packet from the receiving apparatus, and retransmit the transmitted image packets in which the reception completion packet is not received from the receiving apparatus within a predetermined time after the transmitter transmits the transmitted image packet;
wherein the receiving apparatus comprises:
a receiver which is configured to receive the transmitted image packet from the transmitting apparatus; and
a reception completion processor which is configured to transmit a reception completion packet to the transmitting apparatus;
wherein the transmitting or receiving apparatus further comprises:
an image feature setting unit which is configured to set an image feature of the coded image data; and
a first-priority extended layer setting unit which is configured to set a first-priority extended layer that is an extended layer to be retransmitted according to the image feature set by the image feature setting unit, wherein the re-transmitter is configured to retransmit the transmitted image packet of the first-priority extended layer set in the first-priority extended layer setting unit to the transmitting unit, from among transmitted image packets for which the reception completion packet was not received from the receiving completion processor,
wherein the reception completion packet indicates that the transmitted image packet has been received by the receiver.

12. The data transmitting system of claim 11,
wherein the image feature setting unit is configured to set a genre of content images based on metadata of the coded image data;
wherein the first-priority extended layer setting unit is configured to set the first-priority extended layer according to the genre of content images set by the image feature setting unit.

13. The data transmitting system of claim 11,
wherein an extended layer of the coded image data comprises a space layer, a time layer, and a signal to noise (S/N) ratio layer;
wherein the image feature setting unit is configured to set an intensity of motion in content images recorded in the coded image data; and
wherein the first-priority extended layer setting unit is configured to set the time layer as the first-priority extended layer when the intensity of motions of the content images is a predetermined value or above.

14. The data transmitting system of claim 11,
wherein the extended layer of the coded image data comprises a space layer, a time layer, and a signal to noise (S/N) ratio layer;
wherein the image feature setting unit is configured to set an intensity of motion of content images recorded in the coded image data based on motion vector information when the coded image data is coded using a scalable video coding (SVC) method;
wherein the first-priority extended layer setting unit is configured to set the space layer or the S/N ratio layer as the first-priority extended layer when the intensity of motion of the content images is a predetermined level or below.

15. The data transmitting system of claim 11, wherein the data transmitting apparatus further comprises:
a layer identifying unit which is configured to a layer of the coded image data, which is stored in the transmitted image packet transmitted from the transmitting unit, based on layer data; and
wherein the retransmitting unit does not retransmit the transmitted image packet even when the reception completion packet is not received, if the layer identifying determines that the identified layer of coded image data is an extended layer other than the first-priority extended layer by.

16. The data transmitting system of claim 11, wherein the reception completion processor is configured to transmit the reception completion packet to the transmitting apparatus if a transmitted image packet that is not received is of an extended layer other than the first-priority extended layer.

17. The data transmitting system of claim 11,
wherein the receiving apparatus further includes a forward error corrector (FEC) which is configured to execute a forward error correction process based on the transmitted image packet being received by the receiver; and
wherein the reception completion processor is configured to transmit the reception completion packet to the transmitting apparatus, in the case that the transmitted image packet that may not be error-corrected in the FEC is the transmitted image packet is an extended layer other than a first-priority extended layer.

18. The data transmitting system of claim 11,
wherein the extended layer of the coded image data includes a space layer, a time layer, and a signal to noise (S/N) ratio layer;
wherein the image feature setting unit is configured to set an image resolution based on the amount of high-frequency components when the coded image data is coded using a scalable video coding (SVC) method;
wherein the first-priority extended layer setting unit is configured to set the space layer as the first-priority extended layer when the image resolution is a predetermined level or above.

19. A non-transitory computer readable medium comprising computer executable instructions to be executed in a data transmitting system, the instructions configured to execute the operations of:
storing coded image data which includes a base layer and an extended layer, and layer data which represents layers of the coded image data, wherein the image data is coded using a scalable video coding (SVC) method;
setting an image feature of the coded image data;
setting a first-priority extended layer that is an extended layer to be retransmitted according to the image feature;
generating a transmitted image packet which stores the coded image data together with the layer data that corresponds to the coded image data, and transmitting the generated transmitted image packet to a receiving apparatus;
receiving the transmitted image packet from the transmitting apparatus;
transmitting a reception completion packet to the transmitting apparatus, wherein the reception completion packet indicates that the transmitted image packet has been received by a receiving apparatus;
receiving a reception completion packet from the receiving apparatus, and retransmitting the transmitted image packet, from among transmitted image packets in which the reception completion packet is not received from the receiving apparatus within a predetermined time after transmitting the transmitted image packet,
wherein the retransmitting comprises retransmitting the transmitted only an image packet of the first-priority extended layer from among the transmitted image packets in which the reception completion packet is not received from the receiving apparatus.

20. A data transmitting method, the method comprising:
setting an image feature of coded image data;
setting a first-priority extended layer that is an extended layer to be retransmitted according to the image feature; and
retransmitting only an image packet comprising the first-priority extended layer from among transmitted image packets for which a reception completion packet was not received.

21. A data receiving method, the method comprising:
receiving a transmitted image packet;
executing a forward error correction process based on the received transmitted image packet; and
transmitting a reception completion packet indicating that the transmitted image packet has been received in the case that the transmitted image packet may not be error-corrected according to the forward error correction process and is an extended layer other than a first-priority extended layer.
